(19) United States
(12) Patent Application Publication
(10) Pub. No.: US 2018/0230035 A1
(43) Pub. Date: Aug. 16, 2018

(54) SYSTEM AND METHOD OF ODOR CONTROL IN BIOSOLIDS

(71) Applicant: Water Solutions, West Haven, CT (US)

(72) Inventor: Dennis Tomsheck, Stratford, CT (US)

(21) Appl. No.: 15/431,173

(22) Filed: Feb. 13, 2017

(51) Int. Cl. C02F 9/00

(52) U.S. Cl. CPC C02F 9/00; C02F 11/04

(57) ABSTRACT

The present disclosure is directed to a method and system of reducing odor causing compounds in biosolids. The method includes receiving sludge from a wastewater treatment plant, thickening the received sludge to achieve a desired percentage of biosolids in the sludge, generating ClO₂, injecting the ClO₂ into the thickened sludge, exposing the thickened sludge to the ClO₂ for a predetermined period of time sufficient to oxidize the odor causing compounds and dewatering the deodorized thickened sludge to achieve a desired percentage of biosolids, wherein the dewatered biosolids are substantially free of odor.

### BACKGROUND

Methods for the treatment of wastewater to economically and safely produce a useful, soil-like end product, such as for use in soil quality improvement and for increased agricultural productivity have long been sought after in order to economically and effectively deal with the large amounts of wastewater sludge being produced by municipalities and industries. Biosolids is the term used to describe the dewatered, solid organic waste that results from the treatment of municipal wastewater. Since biosolids contain a long list of macro and micronutrients, i.e. nitrogen, phosphorous, and potassium, if properly treated, biosolids can be land applied to maintain and improve soil quality and increase agricultural productivity. Estimates put biosolids production in the US at somewhere around 7,000,000 dry tons annually.

In an effort to encourage the land application of biosolids, thereby reducing the amount of nutrient rich organic material going to landfills, the United States Environmental Protection Agency (USEPA) established a set of rules and practices (CFR Title 40, Part 503) governing how biosolids should be treated, tested, and classified for reuse. These guidelines insure that the land application of biosolids poses no threat to public health, is safe for livestock, and has led to its widespread use for farming, pasturage for livestock grazing, public parks, golf courses, forests crops and in horticulture.

Current methods of treating wastewater, and specifically biosolids, include mesophilic composting, alkaline stabilization, head drying to pellets (solids content>90%), and aerobic or anaerobic digestion. These biosolid treatment processes can produce a product that may qualify as either Class A or Class B with regard to pathogen standards per 40 C.F.R. 503 Rule of the USEPA, however, despite the many obvious benefits to reusing biosolids in agriculture, it is not without drawbacks. One major drawback that has severely and increasingly limited its widespread use is the odor associated with land application. Initially, as the use of biosolids for farming was implemented, everyone recognized that the product did not have a consumer friendly odor profile. For most farmers, however, odors are a normal part of everyday life and they were happy to tolerate odor in exchange for an inexpensive, high quality fertilizer and soil conditioner. As a result wastewater and biosolid treatment efforts emphasized minimizing metals concentration in the product, which was then viewed as the greatest obstacle to public acceptance. But as residential neighborhoods began to encroach upon formerly rural areas, these new neighbors were not so tolerant. Now, community odor complaints and outrage is severely limiting the ability of municipalities to land apply biosolids leading to significant increases in operating expense as disposal costs skyrocket. In some cases, even the landfills will no longer accept biosolids due to odor complaints forcing municipalities to employ even more costly and environmentally undesirable methods of disposal such as incineration.

As a result these biosolid products remain difficult to distribute in many jurisdictions, and even where permitted, it remains a challenge to convince customers that the benefits outweigh the irritations of the odors. While numerous efforts have been made to address this issue, and some limited success has been achieved, improvements are always desirable.

### SUMMARY

The present disclosure is directed to a method and system of reducing odor causing compounds in biosolids. The method includes receiving sludge from a wastewater treatment plant, thickening the received sludge to achieve a desired percentage of biosolids in the sludge, generating ClO₂, injecting the ClO₂ into the thickened sludge, exposing the thickened sludge to the ClO₂ for a predetermined period of time sufficient to oxidize the odor causing compounds and dewatering the deodorized thickened sludge to achieve a desired percentage of biosolids, wherein the dewatered biosolids are substantially free of odor.

In one aspect of the disclosure the thickened sludge is stored in a sludge holding tank. Further, the thickened sludge is mixed prior to injection of the ClO₂ such that the sludge is substantially homogenous. The ClO₂ may be injected into the sludge at a rate of between about 75 and 150 ppm, or a rate of between about 100 and 150 ppm, or a rate of between about 125 and 150 ppm.

The ClO₂ may be exposed to the sludge for between about 30 seconds and 5 minutes, or between about 1 and 4 minutes, or between about 2 and 3 minutes, or for about 3 minutes.

In accordance with another aspect of the disclosure organic matter within the thickened sludge is digested. The digestion may be an anaerobic digestion process.

In accordance with a further aspect of the present disclosure, the thickened and digested sludge is mixed prior to injection of the ClO₂ such that the sludge is substantially homogenous. The ClO₂ may be injected into the sludge at a rate of between about 75 and 150 ppm, or between about 100 and 150 ppm, or between about 125 and 150 ppm. The ClO₂ may be exposed to the sludge for between about 30 seconds and 5 minutes, or between about 1 and 4 minutes, or between about 2 and 3 minutes, or for about 3 minutes.

Any of the above aspects and embodiments of the present disclosure may be combined without departing from the scope of the present disclosure.

### BRIEF DESCRIPTION OF THE FIGURES

Various aspects and features of the present disclosure are described hereinbelow with references to the drawings, wherein:

FIG. 1 is a schematic view of a wastewater treatment process;

FIG. 2 is a schematic view of a sludge treatment process; and

FIG. 3 is a schematic view of an odor reducing sludge treatment process.

### DETAILED DESCRIPTION

The present disclosure is directed to a system and method of treatment of wastewater and sludge to produce biosolids having low to no undesirable odors. The odor causing substances found in biosolids after typical waste treatment processing are small, relatively volatile organic compounds formed by the anaerobic decomposition of organic matter containing sulfur and nitrogen, as well as compounds naturally formed in the digestive track of mammals such as indoles and skatoles. Below is a table of odorous sulfur compounds commonly found in wastewater and sludge:

TABLE 1-1
Odorous Sulfur Compounds in Wastewater (from [X])

| | | Odor Threshold | Molecular |
|---|---|---|---|
| Substance | Characteristic Odor | (ppm) | Weight |
| Allyl Mercaptan | Strong garlic-coffee | 0.00005 | 74.15 |
| Amyl Mercaptan | Unpleasant-putrid | 0.0003 | 104.22 |
| Benzyl Mercaptan | Upleasant-strong | 0.00019 | 124.11 |
| Crotyl Mercaptan | Skunk-like | 0.00003 | 90.19 |
| Dimethyl Sulfide | Decayed vegetables | 0.0001 | 62.13 |
| Ethyl Mercaptan | Decayed Cabbage | 0.0002 | 62.10 |
| Hydrogen Sulfide | Rotten Eggs | 0.0005 | 34.10 |
| Methyl Mercaptan | Decayed Cabbage | 0.0011 | 48.10 |
| Proryl Mercaptan | Unpleasant | 0.00007 | 76.16 |
| Sulfur Dioxide | Purgent, irritating | 0.009 | 64.07 |
| Tert-butyl Mercaptan | Skunk, unpleasant | 0.00008 | 90.10 |
| Thiocresol | Skunk, rancid | 0.00006 | 124.21 |
| Thiophenol | Putrid, garlic-like | 0.00006 | 110.18 |

As can be seen in the table, the presence of even very small amounts of these compounds can create a product with unpleasant odors.

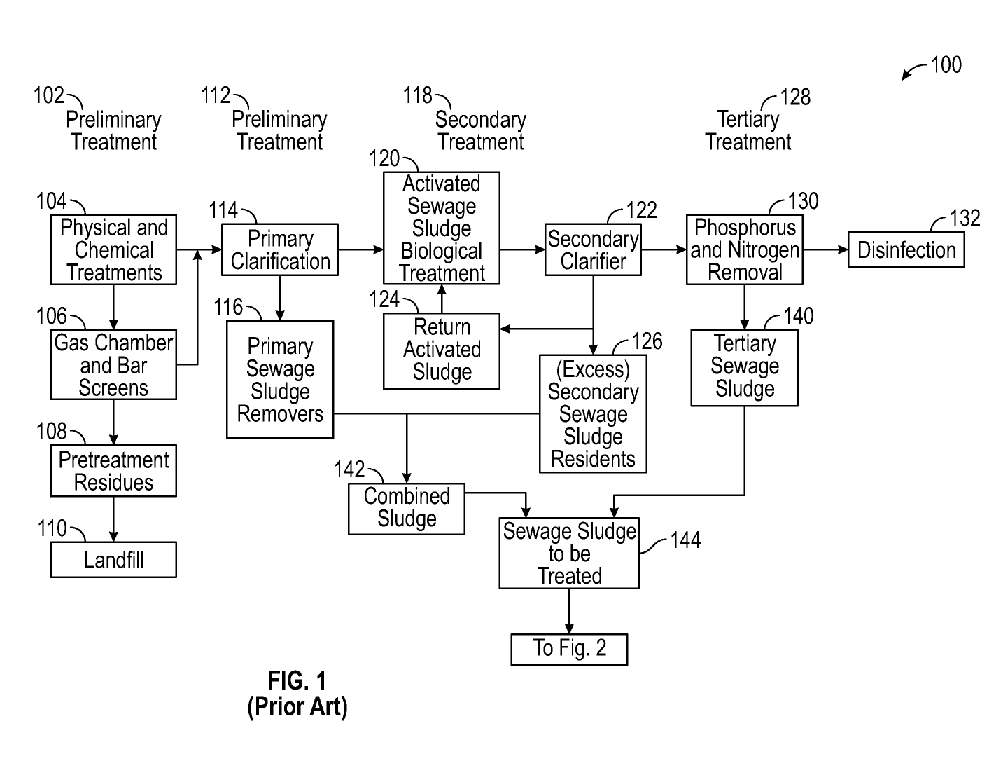

FIG. 1 depicts a common waste water treatment process 100, which is broken into a number of material flows. Initially, a preliminary treatment flow 102 starts with receipt of raw sewage and conducting physical and chemical treatments of the raw sewage at step 104. These physical treatments may include the removal of trash, leaves, branches and the like which might otherwise affect downstream processing. In addition, chemical pre-treatment may be implemented here to encourage sedimentation and removal of certain solids entrained in the incoming sewage. Next in the preliminary treatment flow 102, bar screening and grit removal may be performed at step 106. This bar screening and grit removal helps to eliminate rocks, glass and sand which may find their way into the sewage, and if not removed will become entrained in the system. These pretreatment residues are collected at step 108, and then take to a landfill at step 110, typically without further processing.

The liquid component of the sewage from both the initial physical and chemical treatments step 104 and the bar screening and grit removal 106, is then directed to the primary treatment flow 112, and specifically to a primary clarifier step 114. In the primary clarifier step 114, the pretreated sewage undergoes sedimentation i.e., it is separated with the primary sewage sludge residuals being collected at step 116 and the activated sewage sludge being passed to a secondary treatment flow 118. In the secondary treatment flow 118, the activated sewage sludge receives biological treatments at step 120 typically classified as fixed-film or suspended-growth wherein a biomass is mixed with the sewage to consume biodegradable soluble organic contaminants including sugars, fats, and others. After biological treatment 120, the effluent is passed to a second clarifier at step 122, where again the liquid is separated from the solids via sedimentation. A portion of the solids is returned to biological treatment at step 124, and the remainder is separated into secondary sewage sludge residuals at step 126, which is then combined with the primary sewage sludge residuals from step 116. The liquid component from the second clarifier at step 122 is passed to tertiary treatment flow 128, in which biological nutrients (e.g., nitrogen and phosphorus) are removed at step 130. The liquid effluent may then be disinfected, the process for which may be undertaken in step 132, before being released to the waterways. Any sludge produced in step 130 is collected at step 140 and combined at step 144 with the sludge from steps 116 and 126, shown as combined sludge 142 in FIG. 1, and sent to sludge processing.

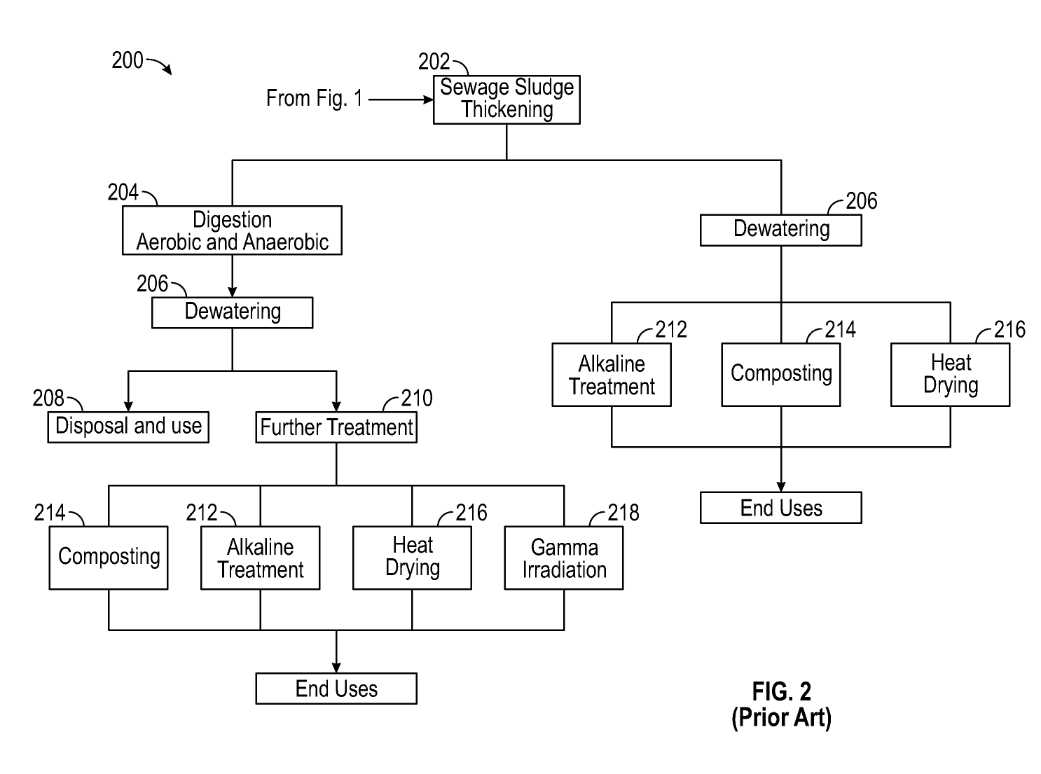

FIG. 2 depicts a common sludge treatment flow 200. At step 202 sludge from step 144 of the wastewater treatment flow is received and treated to thicken the sludge to between 4 and 10 percent biosolids. To sufficiently thicken the sludge one or more clarifying agents may be added to form larger and more rapidly settling aggregates. Once sufficiently thickened, subsequent processing will depend on the nature of the facility. Some facilities are equipped with digesters either aerobic or anaerobic whose purpose is to reduce the amount of organic matter and disease causing micro-organisms in present in the biosolids, this reduction occurs at step 204.

Following digestion at step 204 or in some instances thickening at step 202, the sludge is dewatered at step 206. Dewatering can be undertaken in a number of ways including centrifugation, filtration (e.g., using a belt filter press) or evaporation. After dewatering, the sludge may be handled as a solid containing between about 50 and 75% water (i.e., between 25 and 50% biosolids). One of skill in the art will recognize that dewatered sludges with higher water content can be handled as liquids.

Following dewatering at step 206, if previously digested, at step 208 the biosolids may be collected for disposal in a landfill or use in agriculture as described above. Alternatively, the dewatered biosolids may undergo a variety of further treatments 210 to make them useable to consumers. These further treatments may include alkaline treatments 212, composting 214, heat or evaporative drying 216, and in some instances irradiation 218 (e.g., using gamma rays to eliminate microorganisms). Following these further treatments 210, the resultant dewatered biosolids can be distributed to the end user.

As described above, though some of the odor causing compounds may be eliminated or oxidized to reduce the odor of the biosolids using the further treatment processes 210, significant odors still remain. In part this is due to the primary concern for these further treatments 210 being focused on the reduction of pathogens and microorganisms that can be harmful to people. Indeed, all of the four further treatments 210 are primarily directed at killing microorganisms either directly (e.g., heat drying and gamma radiation) or passively via composting, which induces both heat and microbial elimination of the undesirable microorganisms.

One odor control agent that has been used in a number of applications is chlorine dioxide (ClO₂). For example, rendering plants process unwanted and unused animal parts and tissue, for example, from meat-processing houses and slaughter houses, and convert them into useful finished goods including animal feed, fuel oil, and pharmaceutical ingredients. The air surrounding rendering plant equipment may have a bad odor and due at least in part to the air containing odor causing compounds of the type described above.

Typically air scrubbers are employed to reduce or eliminate the odor. A wet air scrubber operates on the principle that VOCs in the air diffuse into water and consequently are prevented from entering the atmosphere. Air scrubbers may, for example, comprise a tower with water flowing from the top of the tower to the bottom of the tower, with water then recycled to the top of the tower again. As air from a rendering plant is flowed through the air scrubber, VOCs and other odor causing compounds and particulate matter may be removed from the air. While some air scrubbers rely solely on sprayed water to create an air/water interface for purification, others use plastic or stainless steel media to increase air/water surface area and to decrease water flow as the air flows upwards through the scrubber. In addition, an oxidizer such as ClO2, which is readily soluble in water, is often employed to oxidize the VOC's and other compounds resulting in the elimination of the offending odors, or the oxidation of the odor causing compounds into non-odorous compounds. Such systems have been described and used in the rendering plants to treat gaseous wastes and their attendant odors for many years.

One reason that ClO₂ is employed is that it has a unique oxidizing affinity reacting with compounds such as hydrogen sulfide (H₂S), thiols or mercaptans, phenols, and many other odor causing compounds, while simultaneously being non-reactive with other compounds such as ammonia (commonly found in wastewater and sludge) whose presence in the sludge is desirous. The result is that the ClO₂ is very specific in the nature of the compounds with which it reacts and therefore can be used in specifically titrated amounts without fear that it will react with many non-odor releasing compounds. ClO₂ is also a true gas in solution and is not dependent upon the pH of the water/sludge being treated to be effective. Further, ClO₂ can also accept five electrons in an oxidation/reduction reaction versus two electrons for chlorine, bromine, and ozone, giving it two and a half times the oxidative potential of other commonly available oxidizers. Though a variety of uses of ClO₂ have been described in the literature, including in wastewater treatment and composting, effective elimination of odors and the oxidation of the odor forming compounds described above, has not been achieved.

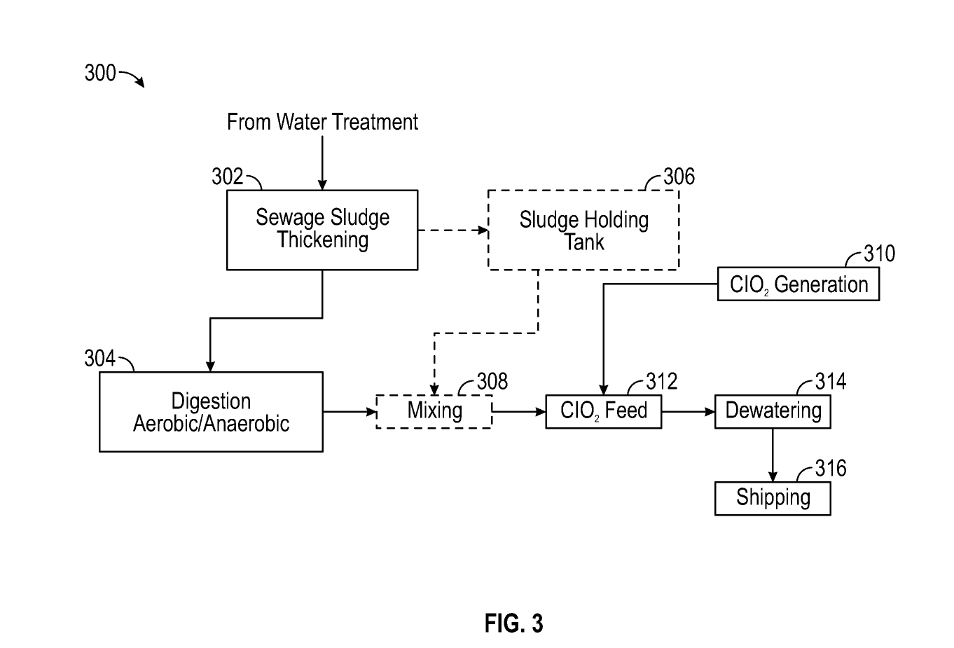

FIG. 3 shows a sludge treatment system 300 in accordance with the present disclosure. In FIG. 3, sludge is received from the wastewater treatment process 100, as described above. This sludge is initially thickened at step 302, where one or more thickening agents may be employed to achieve a desired biosolids percentage, for example 7% (though other percentages may be achieved without departure from the present disclosure). Once thickened at step 302, the process depends on the equipment a particular facility may employ. If the facility includes digesters (e.g., anaerobic digesters) the thickened sludge is fed to the digester 304 where the amount of organic matter and disease causing micro-organisms in present in the biosolids is reduced. One of skill in the art will appreciate that to be an effective fertilizer, soil conditioner or agricultural product, not all organic matter will be eliminated in this step. Alternatively, as in FIG. 2, if the facility does not have a digester, the thickened sludge is transported to a sludge holding tank at step 306. (Note alternative steps are shown by dashed lines and connected with dashed arrows). Following digestion at step 304, depending on the type of digester, being employed the sludge may be sent to a secondary mixer at step 308. Some digesters employ agitation as part of the digestion process ensuring that the sludge coming from the digester is well mixed. In such a system, a mixer step 308 might not be necessary. Similarly, from the sludge holding tank at step 304, the sludge may be directed to a mixer at step 308 to ensure that the sludge is well mixed and relatively homogenous in consistency and viscosity.

A ClO₂ generator is employed locally (e.g., on site) to produce ClO₂ at step 310. ClO₂ generally cannot be manufactured centrally and distributed due to its highly reactive and oxidation properties. Methods of generation of ClO₂ include reacting sodium chlorite and chlorine gas; reacting sodium chlorite, bleach and an acid; reacting sodium chlorite and an acid; using sodium chlorite in a electrolytic cell based ClO2 generator, reacting sodium chlorate, peroxide, and sulfuric acid; and reacting sodium chlorate blended with peroxide and sulfuric acid.

The ClO₂ is fed to the mixed and digested sludge at step 312. This may be directly into a tank that is used for mixing or a separate tank. Alternatively this may be undertaken in piping connecting the digestion tank and the dewatering equipment, where ClO₂ is injected at various stages along the length of the pipe. The pipe would need to have sufficient length to ensure that the sludge would have sufficient time for contact with ClO₂ to ensure through oxidative destruction or any odor causing compounds. In addition to ClO₂ destroying a wide range of odor causing compounds, the reaction is very rapid as compared with other oxidizers such as chlorine and hydrogen peroxide. As a result, there is no need for significant delay as compared to current processes, which as one of skill in the art will appreciate helps to maintain the efficiency of the system, and limits the need for additional holding tanks or processing equipment.

### Prophetic Examples

| Feed Rate | Contact time | Effect |
|---|---|---|
| 75 ppm | 3 minutes | Odors eliminated |
| 100 ppm | 3 minutes | Odors eliminated |
| 125 ppm | 3 minutes | Odors eliminated |
| 150 ppm | 3 minutes | Odors eliminated |

In one embodiment of the present disclosure, the ClO₂ is fed to the sludge at a rate of about 75 ppm with an exposure duration of between 30 second and 5 minutes, preferably between about 1 minute and about 4 minutes, more preferably between about 2 minutes and 4 minutes, and most preferably about 3 minutes.

In a further embodiment of the present disclosure, the ClO₂ is fed to the sludge at a rate of about 100 ppm with an exposure duration of between 30 second and 5 minutes, preferably between about 1 minute and about 4 minutes, more preferably between about 2 minutes and 4 minutes, and most preferably about 3 minutes.

In still a further embodiment of the present disclosure, the ClO₂ is fed to the sludge at a rate of about 125 ppm with an exposure duration of between 30 second and 5 minutes, preferably between about 1 minute and about 4 minutes, more preferably between about 2 minutes and 4 minutes, and most preferably about 3 minutes.

In yet another embodiment of the present disclosure, the ClO₂ is fed to the sludge at a rate of about 150 ppm with an exposure duration of between 30 second and 5 minutes, preferably between about 1 minute and about 4 minutes, more preferably between about 2 minutes and 4 minutes, and most preferably about 3 minutes.

In accordance with a further embodiment of the present disclosure, the ClO₂ is fed to the sludge at a rate of between about 75 and 150 ppm. In accordance with a further embodiment of the present disclosure, the ClO₂ is fed to the sludge at a rate of between about 100 and 150 ppm. In accordance with yet another embodiment of the present disclosure, the ClO₂ is fed to the sludge at a rate of between about 125 and 150 ppm.

Following contact with ClO₂ at step 312 as described herein, the sludge may then be conveyed to a dewatering station at step 314. As noted above, the dewatering may be performed via a belt press or other known techniques to achieve between 50 and 75% water content in the final product (i.e., 25-50% biosolids). These dewatered biosolids have had their odors effectively removed or eliminated such that they can now be processed for shipping and delivery to an intended user at step 316. This step may include bagging the product for the retail consumer market for sale in stores such as HOME DEPOT® or warehousing for bulk distribution to golf courses, agricultural purchasers and municipal purchasers.

Not shown in FIG. 3, but understood by those of skill in the art is that any water separated from the sludge during holding in the digester 304, sludge tank at step 306, and dewatering process 314 may be returned to the wastewater treatment system 100, depicted in FIG. 1.

Detailed embodiments of devices, systems incorporating such devices, and methods using the same as described herein. However, these detailed embodiments are merely examples of the disclosure, which may be embodied in various forms. Therefore, specific structural and functional details disclosed herein are not to be interpreted as limiting, but merely as a basis for the claims and as a representative basis for allowing one skilled in the art to variously employ the present disclosure in appropriately detailed structure.

What is claimed is:

1. A method of reducing odor causing compounds in biosolids comprising:
receiving sludge from a wastewater treatment plant;
thickening the received sludge to achieve a desired percentage of biosolids in the sludge;
generating ClO₂;
injecting the ClO₂ into the thickened sludge;
exposing the thickened sludge to the ClO₂ for a predetermined period of time sufficient to oxidize the odor causing compounds;
dewatering the deodorized thickened sludge to achieve a desired percentage of biosolids, wherein the dewatered biosolids are substantially free of odor.

2. The method of claim 1, further comprising storing the thickened sludge in a sludge holding tank.

3. The method of claim 2 further comprising, mixing the thickened sludge prior to injection of the ClO₂ such that the sludge is substantially homogenous.

4. The method of claim 2, wherein the ClO₂ is injected into the sludge at a rate of between about 75 and 150 ppm.

5. The method of claim 2, wherein the ClO₂ is injected into the sludge at a rate of between about 100 and 150 ppm.

6. The method of claim 2, wherein the ClO₂ is injected into the sludge at a rate of between about 125 and 150 ppm.

7. The method of claim 2, wherein the ClO₂ is exposed to the sludge for between about 30 seconds and 5 minutes.

8. The method of claim 2, wherein the ClO₂ is exposed to the sludge for between about 1 and 4 minutes.

9. The method of claim 2, wherein the ClO₂ is exposed to the sludge for between about 2 and 3 minutes.

10. The method of claim 2, wherein the ClO₂ is exposed to the sludge for about 3 minutes.

11. The method of claim 1, further comprising digesting organic matter within the thickened sludge.

12. The method of claim 11, wherein the digestion is an anaerobic digestion process.

13. The method of claim 11 further comprising, mixing the thickened and digested sludge prior to injection of the ClO₂ such that the sludge is substantially homogenous.

14. The method of claim 11, wherein the ClO₂ is injected into the sludge at a rate of between about 75 and 150 ppm.

15. The method of claim 11, wherein the ClO₂ is injected into the sludge at a rate of between about 100 and 150 ppm.

16. The method of claim 11, wherein the ClO₂ is injected into the sludge at a rate of between about 125 and 150 ppm.

17. The method of claim 11, wherein the ClO₂ is exposed to the sludge for between about 30 seconds and 5 minutes.

18. The method of claim 11, wherein the ClO₂ is exposed to the sludge for between about 1 and 4 minutes.

19. The method of claim 11, wherein the ClO₂ is exposed to the sludge for between about 2 and 3 minutes.

20. The method of claim 11, wherein the ClO₂ is exposed to the sludge for about 3 minutes.
